(19) United States
(12) Patent Application Publication
(10) Pub. No.: US 2006/0044226 A1
(43) Pub. Date: Mar. 2, 2006

(54) Full-color organic electro-luminescent display device

(75) Inventors: Coen theodorus Hubertus Fransiscus Liedenbaum, Eindhoven (NL); Henricus Franciscus Johannus Jacobus Van Tongeren, Knegsel (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/531,612

(22) PCT Filed: Aug. 13, 2003
(86) PCT No.: PCT/IB03/03620

§ 371 Date: Apr. 14, 2005

(30) Foreign Application Priority Data
Oct. 18, 2002 (NL) 1021703

(51) Int. Cl. G09G 3/30

(52) U.S. Cl. 345/76

(57) ABSTRACT

The invention relates to a full-colour organic electro-luminescent display device comprising RGBX-LEDs, wherein the fourth sub-pixel (X) has a higher efficiency than the efficiencies of the RGB sub-pixels. Said device provides a more power efficient generation of white light and other colours, a prolonged life time, and preferably also an extended colour range, in comparison to conventional RGB-LEDs.

The present invention relates to a full-colour organic electro-luminescent display device comprising a plurality of independently addressable fall-colour pixels, each pixel comprising four sub-pixels (RGBX).

An organic electro-luminescent (EL) display device comprises spaced electrodes separated by an organic light-emitting medium which emits electromagnetic radiation, typically light, as a response to the application of an electrical potential between the electrodes. To obtain an image display device, a plurality of individually electrically addressable light-emitting pixels, typically arranged in a matrix. The term pixel refers to an area of a display panel that can be stimulated to emit light independently of other areas.

In a full-colour organic electro-luminescent display, each pixel is divided in sub-pixels. The term sub-pixel refers to any portion of a pixel which can be independently addressable to emit a specific colour.

Typically, a blue, a green, and a red sub-pixel. The red, green, and blue colours constitute the three primary colours which span a colour triangle. All colours within the triangle can be generated by appropriately mixing these colours. By changing an intensive ratio between each of the sub-pixels, a colour tone can be changed.

Thus, each pixel consists of red-green-blue (RGB) light-emitting diodes (LEDs) generally in a planar arrangement. The diode structure generally comprises an anode layer made of a transparent electrode, such as indium tinoxide (ITO), a hole transport layer(s), an organic light-emitting layer, an electron transport layer and a cathode layer made of a metal, such as aluminium, or an alloy, such as magnesium-indium.

When the organic light-emitting layers are made of organic low-molecular substances, the LEDs are referred to as organic LEDs (OLEDs).

When the organic light-emitting layer are made of an (organic) polymer, the LEDs are referred to as polymer LEDs (PLEDs).

Until now, white light has generally been generated by a mixture of red, green, and blue colour. However, this generation of white light is not very efficient with regard to power consumption. Since white light is dominant in most pictures, the generation of white light is a rather important factor for the overall power consumption of the display device.

JP 2000200061 discloses an organic electro-luminescent display comprising pixels constituted of red, green, blue, and white light-emitting sub-pixels (RGBW). When the brightness levels of the colour signals for driving each of the red, green, and blue light-emitting sub-pixels exceed a predetermined value, the white light-emitting sub-pixel is driven to emit light. Thus, below said predetermined value, white light is still generated at a low efficiency by a mixture of red, green and blue light.

An object of the present invention is to provide an organic electro-luminescent display which is more efficient and/or has an extended lifetime.

According to the invention, said object is achieved with a full-colour organic electro-luminescent display device comprising a plurality of independently addressable full-colour pixels, each full-colour pixel (RGBX) comprising four sub-pixels, i.e. a red (R), a green (G), a blue (B) light-emitting sub-pixel, and a fourth additional light-emitting sub-pixel (X), wherein the fourth sub-pixel (X) emits light of a non-white colour with the efficiency of each of the R (red), G (green), and B (blue) sub-pixel.

White light, and any other colour which can be generated by mixing in light from the fourth sub-pixel, can be efficiently generated by mixing light emitted from the fourth sub-pixel and light from at least one of the red, green, or blue light-emitting sub-pixel(s).

Thus, the pixel comprising said fourth sub-pixel (X) enables a more efficient generation of white light than a pixel comprising only RGB sub-pixels. Hence, a lower power consumption is required for the generation of white light.

Preferably, said non-white colour has colour coordinates outside the colour area defined by the colour coordinates corresponding to light emitted from the RGB sub-pixels. An advantage is thus that an extended colour range is provided.

The resulting pixel comprising four sub-pixels is herein referred to as a RGBX-LED (light-emitting diode).

Another advantage of the RGBX-LED according to the invention is that for any colour, two sets of primaries are available. This means that the load on a primary (in terms of life time) can be reduced by a factor of two.

The light-emitting compound in the fourth sub-pixel (X) could either be an organic low-molecular compound or a (organic) polymer.

Preferably, the fourth sub-pixel comprises a polymeric electro-luminescent compound. Thus, the RGBX-LED is preferably a RGBX-PLED (polymer light-emitting diode).

Preferred polymeric electro-luminescent compounds are unsubstituted and substituted poly(para-phenylen-vinylene) (PPV).

One way to generate white light in a full-colour organic electro-luminescent display device according to the invention is to combine light from an additional sub-pixel comprising a yellow/green light-emitting compound and light from the blue light-emitting sub-pixel.

Thus, the non-white colour emitted from the fourth sub-pixel (X) is preferably yellow/green light. Hence, the electro-luminescent compound in the fourth sub-pixel (X) is advantageously a yellow/green light-emitting compound, such as yellow/green light-emitting poly(para-phenylen-vinylene) supplied by Covion Organic Semiconductors GmbH (Frankfurt, Germany), herein referred to as Covion Yellow/Green.

Covion Yellow/Green displays several advantages, such as a high DC-efficiency (about 10 cd/A), a high stability in terms of life time (operative life time >30 000 h), and colour coordinates outside the colour area defined by the colour coordinates corresponding to light emitted from the RGB primaries.

It shall be noted that, for instance, a blue/green light-emitting compound having colour coordinates outside the colour area defined by the colour coordinates corresponding to light emitted from the RGB sub-pixels, may also advantageously be used.

In the full-colour organic electro-luminescent display device according to the invention each full-colour pixel comprises a plurality of subsets of sub-pixels available for emitting light of a desired colour. Said device according to the invention preferably comprises driving means for selectively addressing the subset among the plurality of subsets which provides the desired colour with the highest efficiency or with the longest life time of the sub-pixels. The driving means may be formed electronic circuitry which is adapted, or more specific programmed if programmable electronic circuitry is used, to perform the required selection. The circuitry is conveniently provided in the form of an integrated circuit.

Other features and advantages of the present invention will become apparent from the embodiments described hereinafter.

FIG. 1 shows colour coordinate ranges for primaries in a full-colour display.

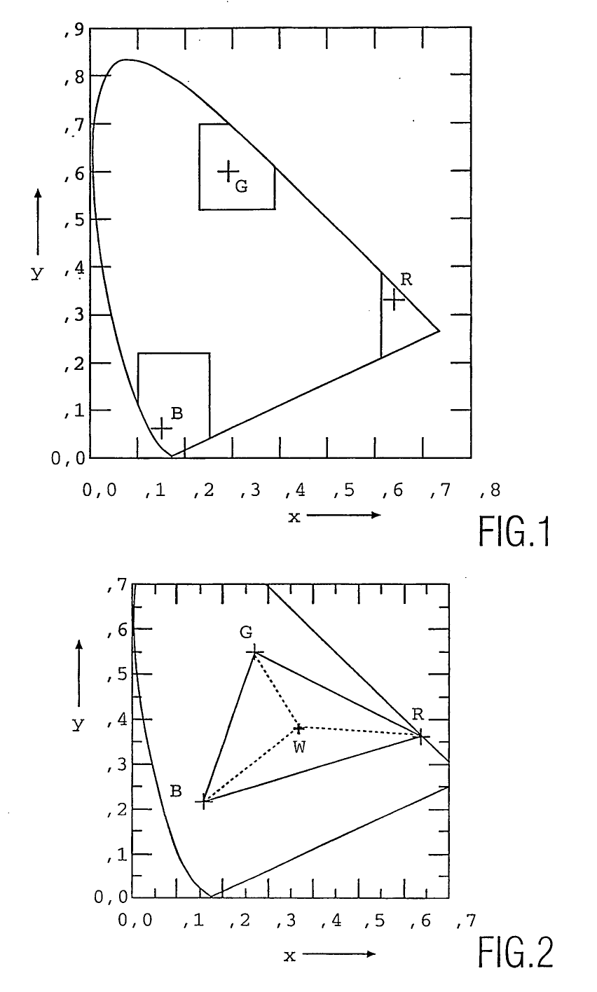

FIG. 2 shows a colour area obtained using a display device comprising RGB primaries.

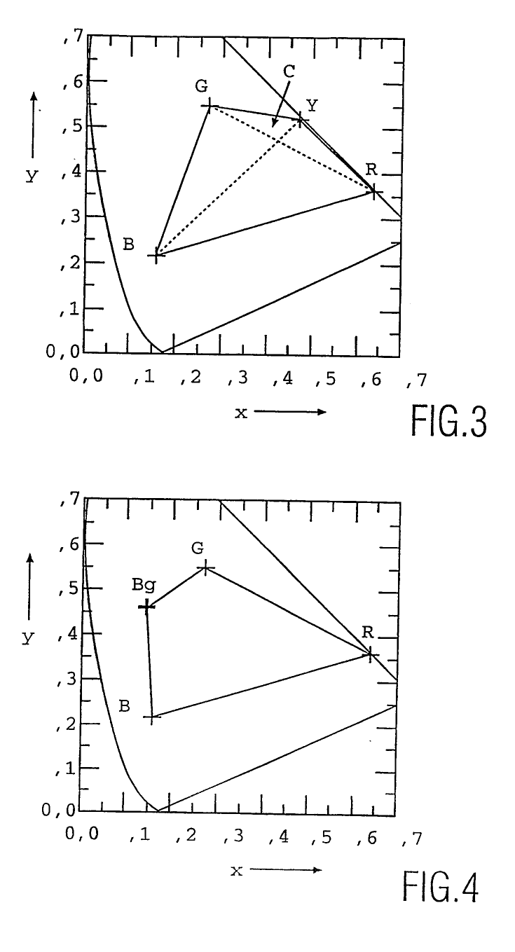

FIG. 3 shows a colour area obtained using an embodiment of a display device comprising RGBX primaries according to the invention.

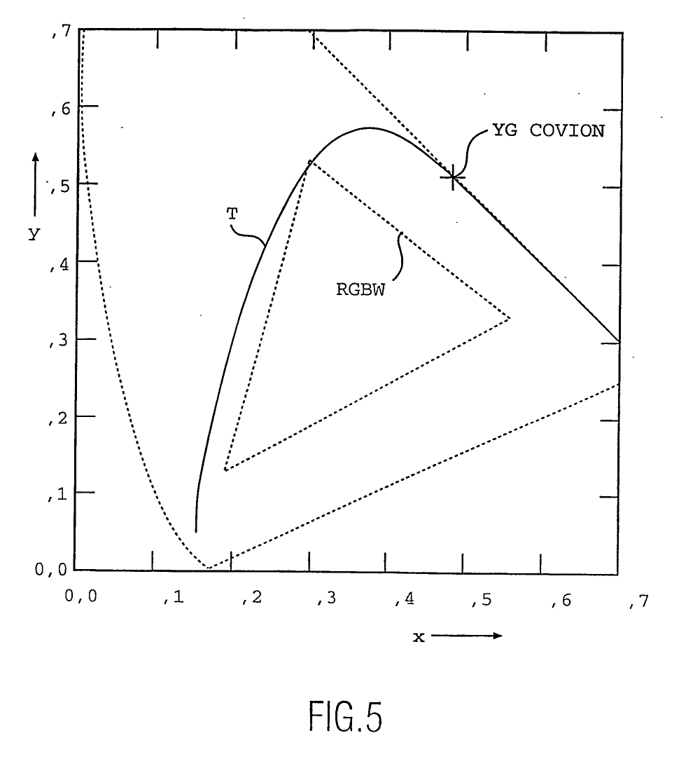

FIG. 4 shows a colour area obtained using an embodiment of a display device comprising RGBX primaries according to the invention.

FIG. 5 shows the estimated colour track obtained by shifting the emission spectrum of Yellow/Green Covion.

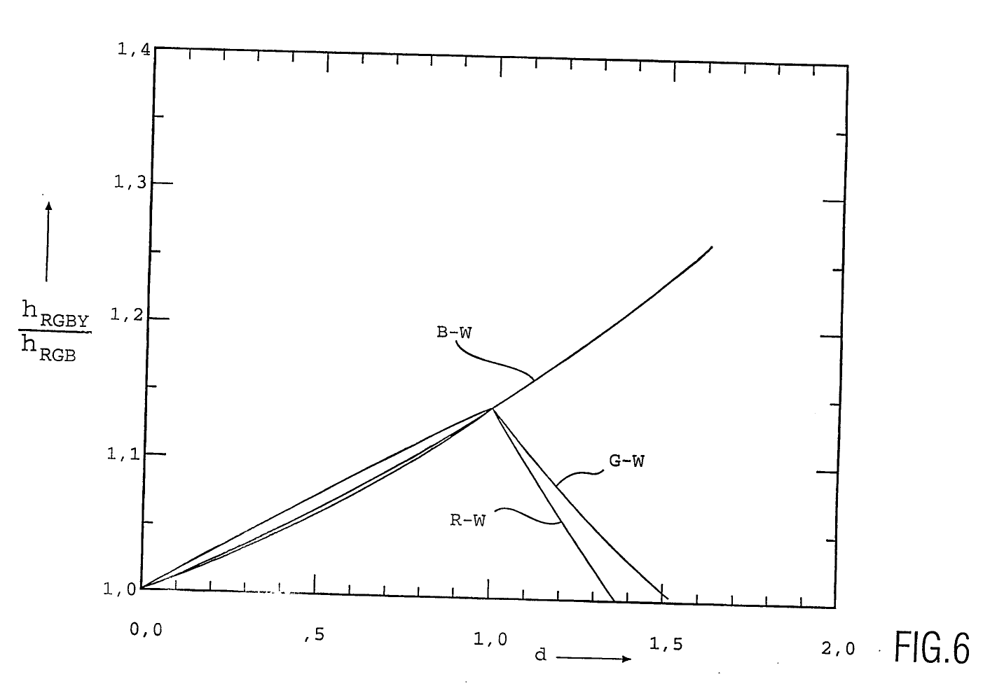

FIG. 6 shows the efficiency ratio η_{RGBY}/η_{RGB} as a function of colour distance (d) for the primaries discussed in Example 1.

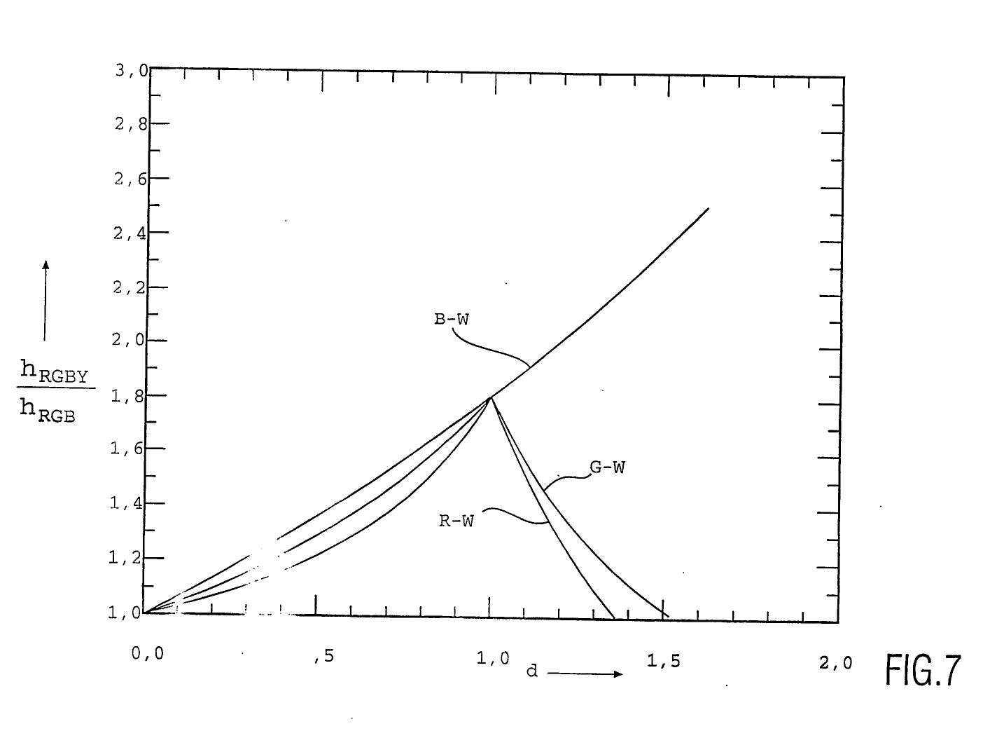

FIG. 7 shows the efficiency ratio η_{RGBY}/η_{RGB} as a function of colour distance (d) for the primaries discussed in Example 2.

FIG. 1 shows the area generally referred to as the “colour triangle”. The so-called EBU (European TV-primaries) coordinates are indicated by the +markers and serve as a reference. The areas bounded by straight lines and the edge of the colour triangle generally serve as primary coordinate ranges.

Thus, light from a red primary generally has colour coordinates within the colour triangle where x>0.61, as shown in FIG. 1.

Light from a green primary generally has colour coordinates within the colour triangle where 0.23<x<0.39 and 0.52<y<0.70, as shown in FIG. 1.

Light from a blue primary generally has colour coordinates within the colour triangle where 0.10<x<0.25 and y<0.22, as shown in FIG. 1.

FIG. 2 shows a colour area defined by colour coordinates for light generated by specific RGB primaries. Any colour within the area can be generated by mixing the right portions of light from the three RGB primaries. For instance, white can be generated by mixing red, blue and green light.

As used herein white light is defined as a colour lacking hue.

As used herein non-white light is defined as a colour having a hue.

As used herein the term “hue” refers to the intensity profile of light emission within the visible spectrum, with different-hues exhibiting visually discernible differences in colour.

FIG. 3 and FIG. 4 show examples of colour areas obtainable by display devices according to the invention. The colour areas are defined by the colour coordinates for light generated by the RGB primaries and an additional light-emitting sub-pixel (X) in accordance with the present invention.

A way to generate white light in a full-colour organic electro-luminescent display device according to the invention is to combine light from the additional sub-pixel and light from at least one of the red, green, or blue light-emitting sub-pixel(s).

The additional sub-pixel (X) preferably emits light having colour coordinates outside the colour area defined by the colour coordinates corresponding to light emitted from the RGB sub-pixels.

FIG. 3 shows a colour area obtained using a display device according to the invention comprising a red (R), a green (G), a blue (B), and a yellow/green (Y) light emitting sub-pixel.

FIG. 4 shows a colour area obtained using a display device according to the invention comprising a red (R), a green (G), a blue (B), and a blue/green (Bg) light emitting sub-pixel.

Thus, as can be seen in FIG. 3 and FIG. 4, an extended colour range is advantageously obtained using a display device according to the invention. A colour quadrangle (RGBX) is obtained instead of the conventional colour triangle (RGB).

Furthermore, the colour area obtained can be divided into several colour triangles. In FIG. 3, these colour triangles are RGB, RBY, RGY, and GBY. Thus, for generation of any colour, such as colour C shown in FIG. 3, two sets of primaries are available, i.e. RGY and GBY in FIG. 3. In other words, each RGBY full-colour pixel comprises two subsets of sub-pixels available for emitting light of a desired colour. This means that the load on a primary (in terms of life time) can be reduced by a factor of two.

Since at least two possible subsets of sub-pixels for generation of a specific colour is provided by the full-colour organic electro-luminescent display device according to the invention, the selection among said sets during driving of the device may either be optimised in view of efficiency or in view of life time of the sub-pixels.

The invention will now be further illustrated by means of the following non-limiting examples.

### EXAMPLES

There are different classes of light-emitting conjugated polymers, such as unsubstituted and substituted poly(para-phenylen-vinylene), e.g. dialkoxy-substituted PPVs, and polyfluorenes.

Unsubstituted poly(para-phenylen-vinylene) emits in the yellow-green region of the visible spectrum.

Dialkoxy-substituted poly(para-phenylen-vinylene) usually emit in the orange (and in some cases yellow) region of the spectrum. Examples are dimethoxy-substituted PPV and MEH-PPV (poly(2-methoxy-5(2′-ethyl-hexyloxy)-para-phenylen-vinylene), which are obtainable from Covion Organic Semiconducturs GmbH (Frankfurt, Germany).

Polyfluorenes usually emit light in the blue-green region of the spectrum. An example is 9,9-dimethyl-substituted polyfluorene, which is obtainable from Covion Organic Semiconductors GmbH (Frankfurt, Germany).

There are also different classes of light-emitting organic low-molecular weight compounds, such as the so-called Spiro compounds available from Covion Organic Semiconducturs GmbH (Frankfurt, Germany). Examples are Spiro-6PP and Spiro Octopus, which emit light in the blue region of the spectrum.

Table 1 shows some polymer LED primaries that currently are commercially available.

TABLE 1

| | CDT-D | Dow-K4 | Covion | Covion |
|---|---|---|---|---|
| | CRed | Green | Blue | Yellow/Green |
| Colour coordinates | 0.650, | 0.388, | 0.156, | 0.438, |
| (x, y) | 0.347 | 0.587 | 0.102 | 0.511 |
| Efficiency [cd/A] | 2.1 | 6.0 | 2.0 | 10 |

CDT-D Red is a red light-emitting polyfluorene available from Cambridge Display Technologies (United Kingdom).

Dow-K4 Green is a green light-emitting polyfluorene available from Dow Chemical Company.

Covion Blue is a blue light-emitting poly(9,9′-spiro-bisfluorene) available from Covion Organic Semiconductors GmbH (Frankfurt, Germany).

Covion Yellow/Green is, as disclosed above, a yellow/green light-emitting poly(para-phenylen-vinylene) available from Covion Organic Semiconducturs GmbH (Frankfurt, Germany). It consists of the units shown in Formula I. 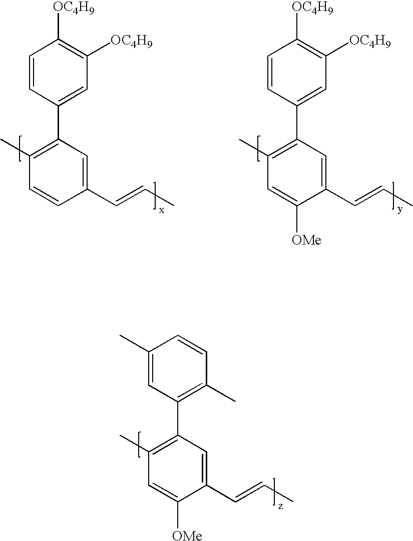
Formula I

As can be seen in Table 1, Covion Yellow/Green emits yellow/green light with a high power efficiency (about 10 cd/A) which is higher than the efficiencies of the RGB primaries. These efficiency values were obtained using a direct current (DC).

Furthermore, Covion Yellow/Green exhibits an extraordinary high stability in terms of life time as compared to other known primaries. Stability is usually tested by an accelerated test, wherein the polymer under test is operated at a constant current level for a long time at 80° C. At regular intervals the emission and required voltage are measured. Generally, life time of a primary is defined as the time point when the emission is decreased to 50% of the initial value. Thus, use of Covion Yellow/Green as a primary improves the stability of the whole display device.

White light can be efficiently generated by mixing yellow/green light and blue light.

In order to get a feeling for the improvement of efficiency, a modelling study is performed as described in the examples below.

### Example 1

The emission spectrum of Covion Yellow/Green shown in Table 1 was shifted to obtain an estimate of colour coordinates and efficiency of suitable RGB primaries. The thus obtained colour track is shown in FIG. 5. As a reference for the colours that should be made by a full-colour PLED-display, the colour area of a so-called RGBW-monitor (RGBW) is shown.

Table 2 indicates suitable RGB primaries to be combined with Covion Yellow/Green. The calculated colour coordinates and efficiencies for said suitable red/green/blue light-emitting (LE) polymers are given in Table 2.

TABLE 2

| | Red LE | Green LE | Blue LE | Covion |
|---|---|---|---|---|
| | polymer | polymer | polymer | Yellow/Green |
| Colour coordinates | 0.628, | 0.300, | 0.158, | 0.438, |
| (x, y) | 0.371 | 0.531 | 0.112 | 0.511 |
| Efficiency [cd/A] | 4.37 | 9.41 | 1.45 | 10 |

White light having colour coordinates of x=0.333 and y=0.327 can be obtained by a luminance mix of 16% blue light and 84% yellow/green light. The efficiency of the white light generation is calculated to be 5.18 cd/A.

White light generated by a luminance mix of the RGB primaries (30% red light, 57% green light and 13% blue light) has a calculated efficiency of 4.54 cd/A.

Thus, an efficiency improvement of about 15% is obtained. However, in real practice, the primaries are often performing well below their theoretical maximum, thus providing a greater efficiency improvement (see Example 2).

To calculate the efficiency of other colours, it is first decided which combinations of primaries that can be used for generation of said colour.

The distance (d) between the white light coordinates and the coordinates of each R/G/B primary is taken to be 1.

As an example, the ratio (η_{RGBY}/η_{RGB}) between the efficiencies obtained using RGBY-LEDs and RGB-LEDs is calculated for colours having coordinates along the R-W, G-W, and B-W colour lines, respectively. These calculated ratios are shown in FIG. 6. As can be seen in FIG. 6, the efficiency ratio increases considerably for colours along the B-W colour line having d>1. All colours up to d=1 are in fact white light diluted with blue light. However, for d>1, more yellow/green light is required and fill advantage of the high-efficient yellow/green light-emitting sub-pixel is thus taken.

### Example 2

Suppose that the RGB primaries given in Example 1 turn out to perform at half the efficiencies of those given in Table 2. The efficiency of Covion Yellow/Green is, however, still 10 cd/A, since this is a value established to be correct. The colour coordinates and efficiencies of these primaries are given in Table 3.

TABLE 3

| | Red LE | Green LE | Blue LE | Covion |
|---|---|---|---|---|
| | polymer | polymer | polymer | Yellow/Green |
| Colour coordinates | 0.628, | 0.300, | 0.158, | 0.438, |
| (x, y) | 0.371 | 0.531 | 0.112 | 0.511 |
| Efficiency [cd/A] | 2.19 | 4.71 | 0.73 | 10 |

To produce white light, the same luminance mix as indicated in Example 1 is still required (16% blue light and 84% yellow/green light), but twice as much current as in Example 1 is needed to produce the blue light.

Thus, the efficiency for generation of white light is only 3.31 cd/A.

This efficiency should be compared to an efficiency of 2.27 cd/A for generation of white light from a luminance mix of red, green, and blue light.

Calculated efficiencies for generation of white light using each combination of halved efficiencies are given in Table 4. For instance, the code [½ 1 1] indicates that the efficiency of the red primary is halved as compared to Example 1, while the green and blue primaries is the same as in Example 1. The codes [1 1 1] and [1 1 1 1] correspond to Example 1.

TABLE 4

| | | | Efficiency | | | | | Efficiency BY- |
|---|---|---|---|---|---|---|---|---|
| | | | RGB-white | | | | | white |
| R | G | B | [cd/A] | R | G | B | Y | [cd/A] |
| 1 | 1 | 1 | 4.54 | 1 | 1 | 1 | 1 | 5.18 |
| ½ | 1 | 1 | 3.45 | ½ | 1 | 1 | 1 | 5.18 |
| 1 | ½ | 1 | 3.57 | 1 | ½ | 1 | 1 | 5.18 |
| 1 | 1 | ½ | 3.21 | 1 | 1 | ½ | 1 | 3.31 |
| ½ | ½ | 1 | 2.86 | ½ | ½ | 1 | 1 | 5.18 |
| 1 | ½ | ½ | 2.69 | 1 | ½ | ½ | 1 | 3.31 |
| ½ | 1 | ½ | 2.63 | ½ | 1 | ½ | 1 | 3.31 |
| ½ | 1 | ½ | 2.27 | ½ | ½ | ½ | 1 | 3.31 |

As can be seen in Table 4, the generation of white light from a luminance mix of blue light and yellow/green light (BY-white) is always more efficient than using a luminance mix of red, green and blue light (RGB-white). Efficiency enhancements of up to 80% is obtainable.

If, for instance, the efficiencies of the red and green EL polymers turn out to be halve the values given in Example 1, i.e. codes [½ ½ 1] and [½ ½ 1 1] in Table 4, the efficiency ratio η_{RGBY}/η_{RGB} given in FIG. 7 is obtained. As can be seen in FIG. 7, the efficiency improvement is quite substantial for colours along the B-W colour line having d>1.

Thus, the above disclosure and the Examples show that the display device according to the invention provides a more efficient generation of white light and other colours than a pixel comprising merely RGB primaries, which means that a lower power consumption is required.

While the invention has been described in detail and with reference to specific embodiments thereof, it will be apparent for one skilled in the art that various changes and modifications can be made therein without departing from the spirit and scope thereof.

1. A full-colour organic electro-luminescent display device comprising a plurality of independently addressable full-colour pixels, each full-colour pixel (RGBX) comprising four sub-pixels, a red (R), a green (G), a blue (B) and a fourth sub-pixel (X), characterised in that the fourth sub-pixel (X) emits light of a fourth non-white colour with an efficiency higher than the efficiency of each of the R (red), G (green), and B (blue) sub-pixel.

2. A full-colour organic electro-luminescent display device according to claim 1, wherein said non-white colour has colour coordinates outside the colour area defined by the colour coordinates corresponding to light emitted from the RGB sub-pixels.

3. A full-colour organic electro-luminescent display device according to claim 1, wherein the fourth sub-pixel comprises a polymeric electro-luminescent compound.

4. A full-colour organic electro-luminescent display device according to claim 3, wherein the polymeric electro-luminescent compound is a poly(phenylene-vinylene).

5. A full-colour organic electro-luminescent display device according to claim 1, wherein the non-white colour emitted from the fourth sub-pixel (X) is yellow/green light.

6. A full-colour organic electro-luminescent display device according to claim 1, wherein each full-colour pixel comprises a plurality of subsets of sub-pixels available for emitting light of a desired colour, and the device comprises driving means for selectively addressing the subset among the plurality of subsets which provides the desired colour with the highest efficiency.

7. A full-colour organic electro-luminescent display device according to claim 1, wherein each full-colour pixel comprises a plurality of subsets of sub-pixels available for emitting light of a desired colour, and the device comprises driving means for selectively addressing the subset among the plurality of subsets which provides the desired colour with the longest life time of the sub-pixels.
